(19) United States
(12) Patent Application Publication
(10) Pub. No.: US 2011/0245387 A1
(43) Pub. Date: Oct. 6, 2011

(54) METHOD FOR PREPARING RUBBER/NANOCLAY MASTERBATCHES, AND METHOD FOR PREPARING HIGH STRENGTH, HIGH IMPACT-RESISTANT POLYPROPYLENE/NANOCLAY/RUBBER COMPOSITES USING SAME

(76) Inventors: Sung Rok Ko, Daejeon (KR); Byung Kook Nam, Daejeon (KR); Chang Hyoo Choi, Daejeon (KR)

(21) Appl. No.: 13/133,564

(22) PCT Filed: Oct. 13, 2009
(86) PCT No.: PCT/KR2009/005885

§ 371 Date: Jun. 8, 2011

(30) Foreign Application Priority Data
Dec. 8, 2008 (KR) 10-2008-0124058

(51) Int. Cl. C08K 5/544; C08K 5/5415; C08L 51/06; C08L 23/20

(52) U.S. Cl. 524/154; 524/188

(57) ABSTRACT

Disclosed herein are a rubber/nanoclay master batch composition and a method for fabrication of a high strength and high impact strength polypropylene/nanoclay/rubber composite composition using the foregoing composition. More particularly, a method for preparation of a rubber/nanoclay master bath using a modified polymer having a high content of maleic anhydride as a compatibilizer is provided. According to the disclosed method, a rubber based nanoclay master batch is prepared and, when added to propylene, may prevent decrease in flexural modulus caused by rubber addition while favorably improving impact strength. In addition, using a maleic anhydride-grafted modified polymer having a high content of maleic anhydride, a rubber/nanoclay master batch composition having excellent dispersibility in polymer may be obtained. Moreover, this rubber/nanoclay master batch composition having a high content of maleic anhydride may be used to manufacture a polypropylene/nanoclay/rubber composite with minimized reduction of flexural modulus and improved impact strength.

### TECHNICAL FIELD

The present invention relates to a rubber/nanoclay master batch resin composition and a method for preparation of high strength and high impact strength polypropylene/nanoclay/rubber composites using the same and, more particularly, a method for preparation of a rubber/nanoclay master batch using a modified polymer having a high content of maleic anhydride as a compatibilizer.

### BACKGROUND ART

Since Toyota Central Research and Development Laboratories developed a nanocomposite by completely exfoliating clay, which has a hydrophilic surface, from a hydrophilic nylon in 1997 and employed the developed composite in a car timing belt cover, an automobile fuel-line, etc., a great deal of research has focused on nanocomposites.

A polymer composite reinforced with a plastic material, especially, organic filler, generally has superior mechanical properties and excellent formability, reduction in weight, or the like, thereby substituting competitive materials such as metal, ceramic, wood, etc., in a variety of industrial applications. In particular, use of a polymer composite having reduced weight, size stability and/or heat resistance required in automotive materials, electric and/or electronic industries is increasing to a wide range of applications. With the introduction of hybrid vehicles, extensive efforts have focused upon methods for reducing vehicle weight. In addition, coming with the environment-friendly era, there is considerable demand for polymer composites exhibiting easy recyclability. In order to decrease weight and improve recyclability of a polymer composite while retaining enhanced physical properties, polymer/clay nanocomposites have recently drawn attention and various approaches to such nanocomposites have been proposed. These polymer/clay nanocomposites have superior overall mechanical properties such as high strength and light weight, as compared to existing polypropylene composites containing typical inorganic additives such as talc. However, the polymer/clay nanocomposites have a drawback of considerably reduced impact strength substantially similar to existing composites, considerably restricting use thereof. Accordingly, extensive studies into improvement of impact strength of polymer/nanoclay have recently been conducted.

With regard to studies into improvement of impact strength of a polypropylene nanocomposite composition and a method for preparation thereof, rubber is generally added during preparing a nanocomposite. However, since addition of rubber causes decrease in flexural modulus despite improvement of impact strength, other attempts to develop a novel technique have yet to be proposed.

Prior arts regarding polypropylene/nanocomposite compositions and methods for preparation thereof have been disclosed, for example, Korean Laid-Open Patent Publication No. 2006-0095158 discloses a method for fabricating a polypropylene/talc/rubber composite which includes adding 5 to 10 wt. % of a polypropylene/nanoclay master batch, in order to prevent flexural modulus from being decreased due to rubber addition. According to this technique, it was found that a polypropylene resin composition including a polypropylene/nanoclay master batch has increased mechanical properties such as tensile strength, flexural strength, flexural modulus, etc., as well as impact strength compatible with such mechanical properties. However, the foregoing improvement serves only to prevent flexural modulus from being decreased by adding a polypropylene/nanoclay master batch, however, cannot solve a principal problem, that is, reduction of flexural modulus due to rubber addition. Therefore, there is still a need to develop innovative materials or techniques capable of preventing reduction of flexural modulus caused by rubber addition.

### DISCLOSURE

### Technical Problem

As a result of intensive and extensive studies to simultaneously improve mechanical strength and impact strength of polypropylene/clay nanocomposites described above, the present inventors have developed a method for preparation of a rubber/nanoclay master batch by mixing nanoclay with rubber and modified polymers, in turn improving impact strength to a desired level while minimizing reduction of flexural modulus caused by rubber addition.

If nanoclay is dispersed in rubber, the nanoclay remains in the rubber even when adding the nanoclay-dispersed rubber to polypropylene, thus preventing flexural modulus from being decreased due to the rubber.

In addition, the present invention uses a modified rubber/nanoclay master batch having a high content of maleic anhydride. In this case, maleic anhydride is physically or chemically combined with hydrophilic nanoclay to facilitate dispersion thereof in a hydrophobic rubber phase, and increasing the content of maleic anhydride may improve the efficiency of nanoclay dispersion.

The present inventors developed a process for remarkably enhancing dispersibility of nanoclay including; adding a rubber/nanoclay master batch composition prepared as described above to a polypropylene resin and then subjecting the mixture to dual extrusion, thus completing the present invention.

### Technical Solution

In order to accomplish the above object, the present invention provides:

(1) A nanoclay master batch composition including 20 to 70 wt. % of rubber resin, 10 to 50 wt. % of nanoclay, and 20 to 50 wt. % of maleic anhydride graft-modified polymer;

(2) The nanoclay master batch composition according to the above (1), wherein the modified polymer is a maleic anhydride-grafted polypropylene resin having a weight average molecular weight of 10,000 to 100,000 and containing 4 to 8 wt. parts of maleic anhydride relative to 100 wt. parts of polypropylene polymer;

(3) The rubber/nanoclay master batch composition according to the above (1), wherein the rubber resin is at least one selected from a group consisting of a polypropylene-ethylene copolymer, a polyethylene-octene copolymer, a polyethylene-butadiene copolymer and EPDM;

(4) The rubber/nanoclay master batch composition according to the above (3), wherein the polyethylene-octene copolymer has a melt flow index of 0.1 to 40 g/10 min, an octene content of 1 to 20 wt. % and a weight average molecular weight of 10,000 to 300,000;

(5) The rubber/nanoclay master batch composition according to the above (1), wherein the nanoclay is an organoclay containing organic onium ions substituted in an interlayer and having an interlayer distance of 10 to 50 Å;

(6) The rubber/nanoclay master batch composition according to the above (5), wherein the organic clay is at least one selected from a group consisting of: a tetraalkyl ammonium salt; a quaternary ammonium salt comprising alkyl and aryl groups; a tetraalkyl phosphonium salt; montmorillonite, hectorite, bentonite, saponite or magadiite intercalated with a quaternary ammonium salt comprising alkyl and aryl groups; and synthetic mica;

(7) A polypropylene/nanoclay/rubber composite including: 1 to 50 wt. % of the rubber/nanoclay master batch composition according to any one of (1) to (6); and 50 to 99 wt. % of polypropylene resin, wherein a rubber resin is further included in an amount of 1 to 40 wt. % relative to a total weight of the composition;

(8) The polypropylene/nanoclay/rubber composite according to the above (7), wherein the rubber resin is at least one selected from a group consisting of a polypropylene-ethylene copolymer, a polyethylene-octene copolymer, a polyethylene-butadiene copolymer and EPDM;

(9) The polypropylene/nanoclay/rubber composite according to the above (7), wherein the composite is a high strength and high impact strength polypropylene/nanoclay/rubber composite having a flexural modulus of 10,000 to 19,000 Kg/cm², a heat deflection temperature of 100 to 140° C., impact strength at a low temperature (−30° C.) ranging from 3 to 10 Kgcm/cm and a specific gravity of 0.91 to 1.0; and

(10) The polypropylene/nanoclay/rubber composite according to the above (7), further including at least one additive selected from a group consisting of antioxidants, UV stabilizers, flame retardants, dyes and plasticizers.

### Advantageous Effects

If a rubber-based nanoclay master batch is prepared and added to propylene, decrease in flexural modulus caused by rubber addition may be prevented while improving impact strength. In addition, the present invention may provide a rubber/nanoclay master batch composition having excellent dispersibility in polymer, which is prepared using a maleic anhydride graft-modified polymer having a high content of maleic anhydride, as well as a polypropylene/nanoclay/rubber composite fabricated using the foregoing rubber/nanoclay master batch composition having a high content of maleic anhydride, which has minimized decrease in flexural modulus and increased impact strength.

### BEST MODE

In order to prevent reduction of flexural modulus due to rubber addition, the present invention does not use a typical polypropylene as a polymer resin required to prepare a nanoclay master batch, instead, adopts a polyethylene rubber copolymerized with octene.

Normal polypropylene has a melting point of about 164° C. and, when subjecting the polypropylene to extrusion, an extruder barrel should be maintained at a temperature of 170 to 200° C. However, extrusion of a nanoclay master batch entails disadvantages such as deterioration in overall physical properties including, for example; significant heat generation caused by high nanoclay content, carbonization of an organic modifier intercalated in the nanoclay in turn generating large amounts of gas, degradation of main chains due to oxidation of polypropylene, or the like.

In contrast, a polyethylene rubber copolymerized with octene has a melting point of 38 to 80° C. and may be extruded even using an extruder barrel having a predetermined temperature of less than 200° C., which is a degradation temperature of an organic nanoclay modifier, thereby attaining excellent thermal stability.

The rubber/nanoclay master batch proposed in the present invention may have reinforced flexural modulus and strength by adding high concentration nanoclay thereto, in order to improve flexural modulus and strength of rubber. It was demonstrated that such strength reinforced rubber/nanoclay master batch can improve impact strength while preventing decrease in flexural modulus when the master batch is added to polypropylene.

According to the present invention, in particular, using a modified polymer copolymerized with at least 4 wt. % maleic anhydride may maximize nanoclay dispersion. Such nanoclay has a layered structure having a thickness of 1 nm and, when dispersing nanoclay having a size of 8 μm, this nanoclay is exfoliated thus generating about 3,000 or more nanoclay layers. Since nanoclay exfoliation extent directly influences strength, the present invention uses a compatibilizer containing a large amount of maleic anhydride, in order to maximize exfoliation of nanoclay which is hydrophilic in a hydrophobic resin or polypropylene resin. With regard to preparation of a nanoclay master batch, maleic anhydride provides a hydrophilic group to a modified polymer, thus facilitating nanoclay exfoliation. Therefore, in consideration of relatively large surface area of the nanoclay, a great amount of modified polymer (copolymerized with maleic anhydride) is required to maximize dispersibility of nanoclay.

A rubber/nanoclay master batch composition according to the present invention comprises: 20 to 70 wt. % of rubber resin; 10 to 50 wt. % of nanoclay; and 20 to 50 wt. % of modified polymer, wherein the modified polymer is a maleic anhydride-grafted polypropylene resin having a weight average molecular weight of 10,000 to 100,000 and containing 4 to 8 wt. parts of maleic anhydride relative to 100 wt. parts of the polypropylene resin.

A high strength and high impact strength polypropylene/nanoclay/rubber composite according to the present invention comprises: 50 to 99 wt. % of polypropylene; and 1 to 50 wt. % of the foregoing rubber/nanoclay master batch composition, and may be fabricated by adding 1 to 40 wt. % of rubber resin to a mixture of polypropylene and the rubber/nanoclay master batch composition, and then, melting and mixing the same.

For preparation of nanoclay master batch, if a content of the rubber resin is less than 20 wt. %, amounts of nanoclay and/or the modified polymer copolymerized with maleic anhydride are excessively increased, thus causing difficulties in extrusion. On the other hand, when a content of the rubber resin exceeds 70 wt. %, an amount of nanoclay is too small, causing difficulties in preventing reduction of flexural modulus of rubber. Therefore, an amount of the rubber resin may suitably range from 20 to 70 wt. %.

### MODE FOR INVENTION

The present invention will be better understood from the following examples. These examples are proposed to illustrate the present invention but are not to be construed as limiting the scope of the invention.

### EXAMPLES

### Example 1

### Preparation of Rubber/Nanoclay Master Batch Composition

(A) As a rubber component, 30, 40 and 50 wt. % of ethylene-octene copolymers, each having a melt flow index of 0.8 g/10 min and an octene content of 12.5%, were respectively used;

(B) As a compatibilizer, 30 wt. % of modified polypropylene having a maleic anhydride content of 4 wt. % and a weight average molecular weight of 40,000, was used; and

(C) As an organic nanoclay component, 20, 30 and 40 wt. % of organic nanoclays I.44P (manufactured by Nanoco, U.S.A.) were respectively used.

The foregoing components were mixed in a relative mixing ratio, introduced into a Henschel mixer, and then sufficiently mixed for 2 minutes, that is, at 500 rpm for 1 minute and then at 1500 rpm for 1 minute. Next, using a co-rotating biaxial extruder having an L/D ratio of 40 at 160 to 180° C. under processing conditions of 500 rpm, a rubber/nanoclay master batch composition was prepared. According to constitutional ratios, three prepared compositions are represented by M/B1, M/B2 and M/B3 in the following Table 1.

TABLE 1

| | M/B1 | M/B2 | M/B3 |
|---|---|---|---|
| Clay (%) | 20 | 30 | 40 |
| Compatibilizer (%) | 30 | 30 | 30 |
| Rubber (%) | 50 | 40 | 30 |
| Specific gravity | 0.98 | 1.0 | 1.1 |

### Example 2

### Fabrication of Polypropylene/Nanoclay/Rubber Composite

(A) 5, 10, 15, 20 and 25 wt. % of the rubber/nanoclay master batches (M/B3) prepared in Example 1, respectively; and

(B) as a polypropylene resin component, 95, 90, 85, 80 and 75 wt. % of polypropylenes copolymerized with 7.7 wt. % of ethylene, each of which has a melt flow index of 35 g/10 min and a weight average molecular weight of 216,000, were respectively mixed and processed by the same procedures as described in Example 1, thus fabricating respective polypropylene/nanoclay/rubber composites.

Using each of the fabricated composites as a specimen, physical properties thereof were measured according to the following ASTM standards. Measured results are shown in the following Table 2.
Melt flow index: measured at 230° C. under 2.16 kg according to ASTM D1228;
Density: measured using a specimen having a thickness of 2 mm according to ASTM D1505;
Flexural strength and flexural modulus: measured using a specimen having a thickness of 6 mm at a span of 100 mm and a yarn speed of 5 mm/min, according to ASTM D790;
Heat deflection temperature (HDT): measurement of temperature at which deflection initiates, using an HDT test at 4.6 kg load.

TABLE 2

| | Item | NC1 | NC2 | NC3 | NC4 | NC5 |
|---|---|---|---|---|---|---|
| Recipe | M/B3 (%) | 5 | 10 | 15 | 20 | 25 |
| | PP (%) | 95 | 90 | 85 | 80 | 75 |
| Phys- | Flexural mod- | 14,710 | 15,550 | 16,400 | 17,240 | 18,090 |
| ical | ulus (Kg/cm²) | | | | | |
| proper- | Izod (Kgcm/cm) | 37 | 39 | 42 | 44 | 45 |
| ties | Impact strength | 5.3 | 5.2 | 5.1 | 5.2 | 5.3 |
| | at - 30 ° C. | | | | | |
| | (Kgcm/cm) | | | | | |
| | HDT (° C.) | 111 | 112 | 111 | 113 | 112 |

As described in Comparative Example 1 below, the polypropylene/rubber composite containing rubber added thereto shows marked decrease in flexural modulus when the rubber content is increased. On the other hand, the product prepared in Example 1, by adding the rubber/nanoclay master batch in the same amount as the rubber in Comparative Example 1, exhibited a surprising result in that flexural modulus is improved while impact strength remains the same. The increase in flexural modulus is due to addition of nanoclay in an increased proportion of M/B3 content.

### Comparative Example 1

### Fabrication of Polypropylene/Rubber Composite

(A) As a rubber component, 5, 10, 15, 20 and 25 wt. % of ethylene-octene copolymers, each of which has a melt flow index of 0.8/10 min and an octene content of 12.5 wt. %, respectively; and

(B) as a polypropylene resin component, 95, 90, 85, 80 and 75 wt. % of polypropylene copolymerized with 7.7 wt. % of ethylene, each of which has a melt flow index of 35 g/10 min and a weight average molecular weight of 216,000, were respectively mixed and processed by the same procedures as described in Example 1, thus fabricating polypropylene/nanoclay/rubber composites, respectively.

According to constitutional ratios, the fabricated products are represented by PR1, PR2, PR3, PR4 and PR5, respectively, in the following Table 3. These products were subjected to assessment of physical properties according to the same procedures as described in Example 2.

TABLE 3

| | Item | PR1 | PR2 | PR3 | PR4 | PR5 |
|---|---|---|---|---|---|---|
| Recipe | Rubber (%) | 5 | 10 | 15 | 20 | 25 |
| | PP (%) | 95 | 90 | 85 | 80 | 75 |
| Phys- | Flexural modulus | 12,900 | 11,500 | 10,500 | 9,450 | 8,400 |
| ical | (Kg/cm²) | | | | | |
| proper- | Izod (Kgcm/cm) | 9.7 | 14.3 | 25 | 49 | 73.4 |
| ties | Impact strength at - | 5.7 | 6.7 | 7.6 | 9.2 | 10.8 |
| | 30° C. (Kgcm/cm) | | | | | |
| | HDT (° C.) | 108 | 99 | 98 | 94 | 91 |

### Example 3

### Fabrication of Polypropylene/Nanoclay/Rubber Composite

(A) 17.5 and 25 wt. % of the rubber/nanoclay master batches 3 (M/B3) prepared in Example 1, respectively;

(B) as a polypropylene resin component, 68.8 and 59 wt. % of polypropylene copolymerized with 7.7 wt. % of ethylene, each of which has a melt flow index of 35 g/10 min and a weight average molecular weight of 216,000, respectively; and

(C) as a rubber component, 13.7 and 16 wt. % of ethylene-octene copolymers, each of which has an octene content of 12.5 wt. %, were respectively mixed and processed by the same procedures as described in Example 1, thus fabricating respective polypropylene/nanoclay/rubber composites. According to constitutional ratios, the fabricated products are represented by NCP1 and NCP2, respectively, in the following Table 4. These products were subjected to assessment of physical properties according to the same procedures as described in Example 2.

TABLE 4

| | Item | NCP1 | NCP2 |
|---|---|---|---|
| Recipe | M/B3 (wt %) | 17.5 | 25 |
| | PP (wt %) | 68.8 | 59 |
| | Rubber (wt %) | 13.7 | 16 |
| Constitutional | Clay (wt %) | 7 | 10 |
| ratio | Compatibilizer (wt %) | 4.2 | 6 |
| | Overall rubber (wt. %) | 20 | 25 |
| Physical | Density (g/cm³) | 0.92 | 0.93 |
| properties | Flexural modulus (Kg/cm²) | 13,800 | 11,600 |
| | Impact strength (Kgcm/cm) | 57.2 | 64.3 |
| | Impact strength at −30° C. | 5.5 | 6.5 |
| | (Kgcm/cm) | | |
| | HDT (° C.) | 105 | 96 |
| | Shrinkage (%) | 0.72 | 0.54 |

The rubber component was added to experimentally demonstrate that a high strength and high impact strength polypropylene/nanoclay/rubber composite may be fabricated, which exhibits improved impact strength without decrease in strength, even if rubber is additionally contained besides the rubber/nanoclay master batch according to the present invention.

As compared to Comparative Example 1, it can be seen that the polypropylene/nanoclay/rubber composites fabricated in Example 3 according to the present invention exhibit excellent results such as remarkable increase in flexural modulus of 4,350 Kg/cm² and 3,200 Kg/cm², respectively, at the same rubber content, although they have considerably high overall rubber contents of 20 and 25 wt. %, respectively, by adding rubber components.

1. A rubber/nanoclay master batch composition, the composition comprising:
20 to 70 wt. % of rubber resin; 10 to 50 wt. % of nanoclay; and 20 to 59 wt. % of maleic anhydride graft-modified polymer.

2. The composition according to claim 1, wherein the modified polymer is a maleic anhydride-grafted polypropylene resin having a weight average molecular weight of 10,000 to 100,000 and containing 4 to 8 wt. parts of maleic anhydride relative to 100 wt. parts of the polypropylene resin.

3. The composition according to claim 1, wherein the rubber resin is at least one selected from a group consisting of a propylene-ethylene copolymer, a polyethylene-octene copolymer, a polyethylene-butadiene copolymer and EPDM.

4. The composition according to claim 3, wherein the polyethylene-octene copolymer has a melt flow index of 0.1 to 40 g/10 min, an octene content of 1 to 20 wt. % and a weight molecular weight of 10,000 to 300,000.

5. The composition according to claim 1, wherein the nanoclay is an organoclay containing organic onium ions substituted in an interlayer and having an interlayer distance of 10 to 50 Å.

6. The composition according to claim 5, wherein the organoclay is at least one selected from a group consisting of: a tetraalkyl ammonium salt; a quaternary ammonium salt comprising alkyl and aryl groups; a tetraalkyl phosphonium salt; montmorillonite, hectorite, bentonite, saponite or magadiite intercalated with quaternary ammonium salts comprising alkyl and aryl groups; and synthetic mica.

7. A polypropylene/nanoclay/rubber composite, comprising: 1 to 50 wt. % of the rubber/nanoclay mater batch composition as set forth in any one of claims 1 to 6; and 50 to 99 wt. % of polypropylene resin, wherein a rubber resin is further included in an amount of 1 to 40 wt. % relative to a total weight of the composition.

8. The composite according to claim 7, wherein the rubber resin is at least one selected from a group consisting of a polypropylene-ethylene copolymer, a polyethylene-octene copolymer, a polyethylene-butadiene copolymer and EPDM.

9. The composite according to claim 7, wherein the composite is a high strength and high impact strength propylene/nanoclay/rubber composite having a flexural modulus of 10,000 to 19,000 Kg/cm², a heat deflection temperature of 100 to 140° C., impact strength at a low temperature (−30° C.) ranging from 3 to 10 Kgcm/cm and a specific gravity of 0.91 to 1.0.

10. The composite according to claim 7, further comprising at least one additive selected from a group consisting of antioxidants, UV stabilizers, flame retardants, dyes and plasticizers.
